(19) United States
(12) Patent Application Publication
(10) Pub. No.: US 2002/0109829 A1
(43) Pub. Date: Aug. 15, 2002

(54) Single aperture, alignment insensitive ladar system

(76) Inventor: Cecil L. Hayes, Placentia, CA (US)

Correspondence Address: Cleveland R. Williams, Suite 100, 2501 East Chapman Avenue, Fullerton, CA, 92631, US

(21) Appl. No.: 10/120,987

(22) Filed: Apr. 10, 2002

Related U.S. Application Data
(63) Continuation-in-part of application No. 09/428,443, filed on Oct. 28, 1999.

(51) Int. Cl. G01C 3/08

(52) U.S. Cl. 356/4.01

(57) ABSTRACT

This invention resides in a laser radar system for targeting both moving and stationary targets, which is insensitive to alignment errors introduced by mechanical and acoustic perturbations. The laser radar system includes a laser source for projecting a beam of stable, optical, polarized radiation, three separate polarized beam expanders, a think film polarizer, internal optics including a retroreflector, output optics, a 50-50 beam separator, two separate signal detectors for converting electronic signals to analog and a processor for converting analog electronic signals to digital. The optical assembly is configured to compensate for induced misalignment and maintains optimized heterodyne operation in harsh environments.

This Patent Application is a continuation-in-part of patent application Ser. No. 09/428,443, which was filed on Oct. 10, 1999.

### BACKGROUND OF THE INVENTION

The present invention relates to a laser radar (LADAR) system, which is especially suitable for targeting moving and stationary targets. In particular, the system comprises a laser source and optical configuration in combination with detectors and a processor for obtaining an alignment insensitive system suitable for operation in a hostile environment, for example airborne applications.

LADAR systems have been operated and characterized since shortly after the invention of the laser. Configurations involving both incoherent (direct detection) and coherent (heterodyne detection) receivers have been used. If maximum sensitivity or retention of phase information is desired, the heterodyne receiver is required. To meet the criteria for successful operation of the coherent system, an optical mixing element to combine a local oscillator beam with the return signal beam is necessary. To be successful, this interferometer must maintain optical alignment to within one-quarter of a fringe. This condition is easily mechanized within the laboratory environment, but is subject to misalignment in environments exhibiting high levels of vibrational and acoustical disturbances.

The present invention is directed toward providing a single aperture, optical interferometer which is insensitive to misalignment and functions as a transmit/receive LADAR system in either a homodyne or heterodyne mode.

### SUMMARY OF THE INVENTION

The present invention is directed to a laser radar system for targeting moving and stationary targets which comprises: a laser source for projecting a beam of stable, optical, polarized radiation, to a first beam expander, having adjustment means, transmitting the expanded polarized radiation to a thin film polarizer, means for splitting the radiation beam from the thin film polarizer to output optics and internal optics, wherein the radiation beam from the splitting means is transmitted to a quarter-wave plate (output optics) and a third beam expander, having adjustment means, to a target area, reflected radiation beams from the target area are reflected back through the third beam expander, quarter-wave plate (output optics) and polarizing beam splitting means to a 50-50 beam separator where the beam is directed to a first detector containing focusing lens and a second detector containing focusing lens, radiation from the polarizing splitting means is transmitted through an iris containing a quarter-wave plate (internal optics) and a second beam expander, having adjustment means, to a retroreflector where it is reflected back through the second beam expander, internal optics and beam polarizing splitting means to the 50-50 beam separator where it is combined with the reflected radiation beams from the target area and transmitted to first and second detection means and to processor means.

### BRIEF DESCRIPTION OF THE DRAWINGS

FIG. 1 is a schematic diagram of an alignment insensitive homodyne laser radar.

FIG. 2 is a schematic diagram of alignment insensitive offset-heterodyne laser radar.

### DETAILED DESCRIPTION OF THE INVENTION

The present invention resides in a laser radar system, which targets moving and stationary targets, which maintaining optimum optical alignment for heterodyne detection.

Embodiments of the laser radar system of the present invention are hereinafter described with reference to the drawings, in which identical or corresponding elements are indicated by the same reference characters through the several views.

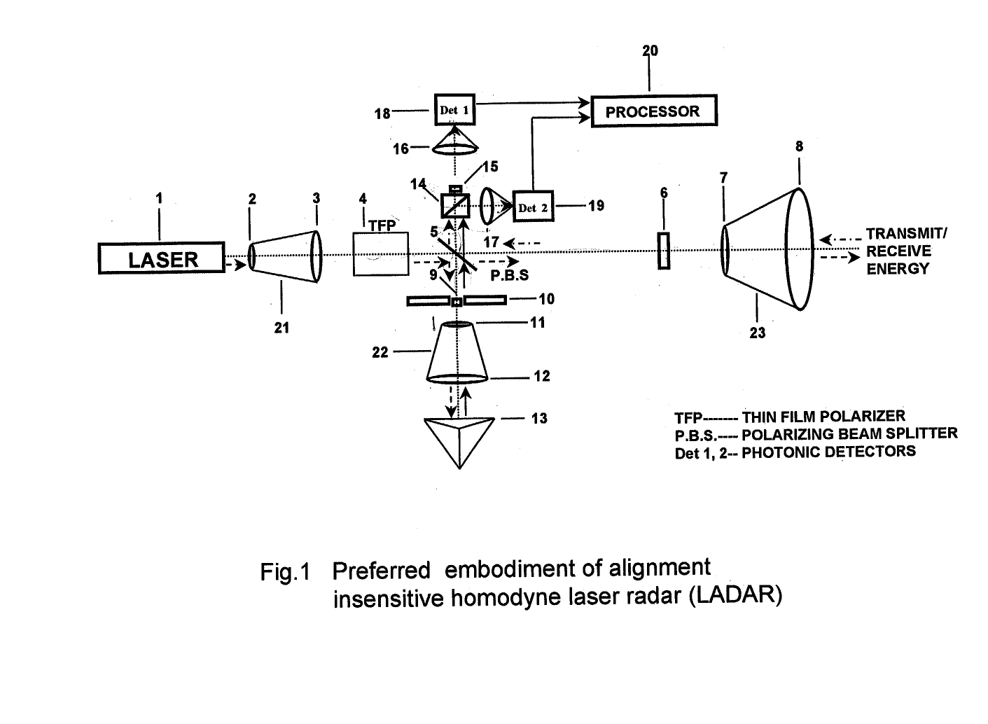

FIG. 1 illustrates a schematic diagram of an alignment insensitive homodyne laser radar system comprising laser 1, which is a source of monochromatic, optical radiation. Desirable lasers include carbon dioxide lasers and solid state lasers. Radiation from laser 1 is transmitted to first optical beam expander 21 where optical output energy of laser 1 is expanded by lens 2 and lens 3. It should be noted that the lens of the beam expanders herein are typically constructed from zinc selenide or other types of lens that passes the radiation therethrough. The optical beam expanders herein are optical devices composed of multiple lens combinations, which expand the input beam in size and recollimates the output beam at a larger size.

First optical beam expander 21 has adjustment means for changing the distance between lens 2 and 3, wherein the beam wave can be changed from convex to plane to concave in first beam expander 21. Typical adjustment means include a screw mechanism for either moving lens 2 closer to lens 3 or for moving lens 2 farther from lens 3.

The expanded optical beam from beam expander 21 is transmitted to thin film polarizer 4 which is utilized to reject any unwanted backscatter into laser 1. Thin film polarizer 4 is an optical device used to discriminate between the two planes of optical polarization (P and S). Typical operation of an optical substrate at Brewster's angle permits transmission of the P-plane of polarization and rejection of a high percentage of S-plane polarization. In the infra red region, the thin film polarizers herein contain zinc-selenide plates having plane parallel surfaces. Thin optical film coatings on the film of a substrate, such as the plates herein, are used to further enhance this effect.

Next, the optical polarized radiation from thin film polarizer is transmitted to polarizing beam splitter 5 which performs a polarization discrimination function by dividing the beam into two beams of differing polarization without changing the beam shape. In the infra red region, the beam splitter 5 is typically constructed from zinc selenide and is configured with thin film coatings to operate at an angle of incidence of 45 degrees.

Polarizing beamsplitter 5 transmits a predetermined amount of optical radiation to output optics comprised of quarter-wave plate 6 and third beam expander 23, having adjustment means, which contains lens 7 having expansion properties and lens 8 having collimating properties, optical radiation is transmitted from third beam expander 23 to a target which can be either moving or stationary. The optical radiation is reflected off the target and back through third beam expander 23 and quarter wave plate 6 to beamsplitter 5. Adjustment means for third beam expander 23 includes a screw mechanism for moving lens 7 either toward or farther away from lens 8.

The residual energy reflected by beamsplitter 5 is used as a local oscillator for heterodyne detection. Upon reflection, the local oscillator energy passes through iris 10 to control the intensity level and then, through quarter-wave plate 9 to introduce an optical radiation beam having circular polarization properties to second beam expander 22 which contains lens 11 having expansion properties and lens 12 having collimating properties. The optical radiation beam is transmitted from iris 10 to retroreflector 13, which comprises three orthogonal planes of reflection. Optical beams or rays entering the aperture of retroreflector 13, exits with diametrical offset relative to the optical axis thereof. The optical beam is reflected from retroreflector 13 through second beam expander 22 back along the outward pass to quarter-wave plate 9 where upon exiting said quarter-wave plate 9, the beam is again linearly polarized orthogonally to its entrance state. Beam expander 22 serves to enlarge the beam and also provide curvature adjustment means of the local wavefront returned by retroreflector 13. Curvature adjustment means is accomplished by moving lens 11 either closer to or farther from lens 12 for example by using a screw mechanism. A predetermined fraction of the optical radiation controlled by iris 10 is transmitted through polarizing beamsplitter 5 and constitutes the local oscillator of the system. The fraction of energy which is reflected at beamsplitter 5 impinges upon thin film polarizer 4 and is nearly completely reflected, insuring that a negligent amount of energy returns to the laser source.

Signal laser energy returning from the transmit target path is reflected through third beam enlarger 23 and quarter-wave plate 6 where it is orthogonally polarized by quarter-wave plate 6 and combined with the local oscillator beam from retroreflector 13 upon reflection from beamsplitter 5.

Since the beamsplitter 5 is a device which has been fabricated with plane-parallel faces to a high precision and the retro reflector 13 always returns the reflected energy back along its outward path with high precision, the signal and local oscillator beams are always aligned with high precision. External disturbances cannot introduce misalignment. This feature provides an alignment insensitive characteristic needed to operate in a hostile environment.

The combined energies (signal and local oscillator) are propagated to beamsplitter 14, which divides the total energy. One-half the energy is directed to focusing lens 17 and applied to the detector 19. One-half the energy is directed to focusing lens 16 and applied to detector 18. The local oscillator portion is first directed to the retardation plate 15 to introduce a π/2 retardation. This energy combines with the signal energy at detector 18 and provides a signal in quadrature with the output of detector 19. Both signals are now transmitted to the processor 20.

It is to be noted that the detectors (18 and 19) herein are optical devices, which convert photon energy to electronic energy with a specified conversion efficiency. The processor 20 accepts electronic signals from the detectors and converts the information contained in the signals to a usable format, e.g. analog or digital. Output variables are, the Doppler shift (target velocity), harmonic modulation of the signals and time of flight data (phase or temporal).

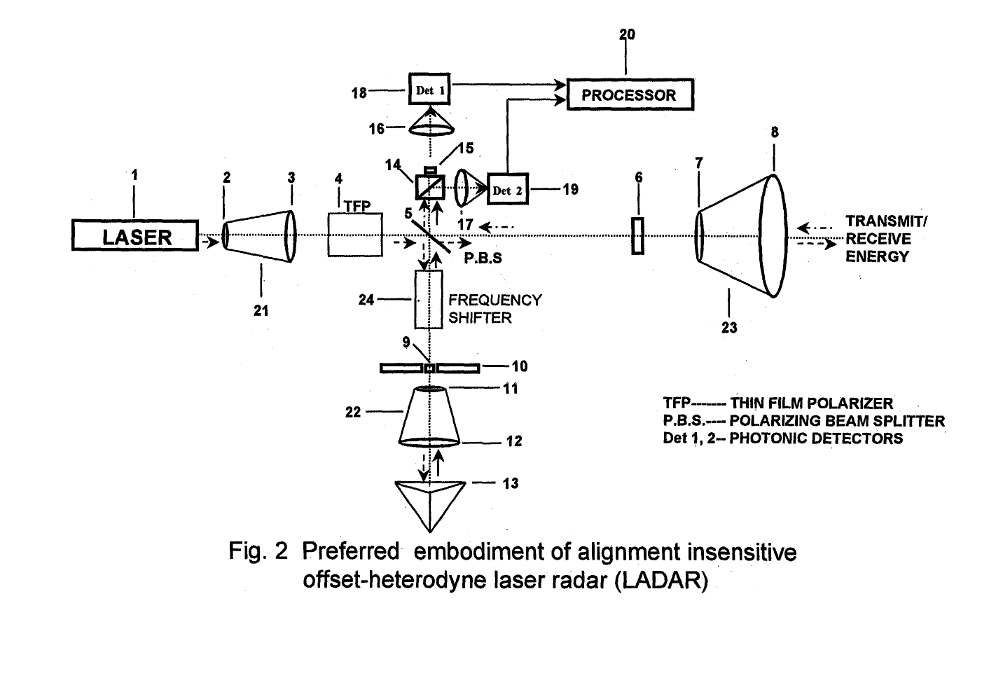

FIG. 2. Is the same as FIG. 1. with the following exception: a frequency shifter 24 is located in the local oscillator path. Frequency shifter 24 is preferably a frequency generator wherein the frequency desired can be dialed in, thus changing the frequency of optical radiation. This feature converts the laser radar system herein to an alignment insensitive offset-heterodyne laser radar system.

While the invention has been described in its presently preferred embodiments, it is understood that the words which have been used are words of description rather than words of limitation and that change within the preview of the appended claims may be made without departing from the scope and spirit of the invention in its broader aspects.

I claim:

1. A laser radar system for targeting moving and stationary targets which comprises: A laser source for projecting a beam of stable, optical, polarized radiation, to a first beam expander, having adjustment means transmitting the expanded polarized radiation to a thin film polarizer, polarizing beam splitter means for splitting the radiation beam from the thin film polarizer to output optics and internal optics, wherein the radiation beam from the output optics is transmitted to a third beam expander having adjustment means, to a target area reflected radiation beams from the target area are reflected back through the third bean expander, output optics and polarizing splitting means to a 50-50 beam separator where the beam is directed to a first detector through a focusing lens and a second detector through a focusing lens; radiation from the polarizing splitting means is transmitted through internal optics to a second beam expander having adjustment means and retroreflector where it is reflected back in a reciprocal path through the second beam expander and internal optics to beam polarizing splitting means where it is combined always colinearly with the reflected radiation beams from the target area and transmitted to the 50-50 beans separator then to first and second detection means and to processor means.

2. The laser radar system of claim 1, wherein the first, second and third radiation beam expanders contain a first lens having expansion properties and a second lens having collimating properties.

3. The laser radar system of claim 2, wherein the first, second and third radiation beam expanders contain adjustment means for moving the first lens towards the second lens.

4. The laser radar system of claim 2, wherein the first, second and third radiation beam expanders contain adjustment means for moving the first lens away from the second lens.

5. The laser radar system of claim 1, wherein the thin film polarizer rejects unwanted backscatter radiation back into the laser source.

6. The laser radar system according to claim 1, wherein the means for splitting the radiation beam comprises a polarizing beam splitter at a 45-degree angle for both output optics and internal optics.

7. The laser radar system of claim 1, wherein the internal optics comprises a quarter-wave plate attached to an iris.

8. The laser radar system of claim 1, wherein the beam separator comprises a housing unit containing a first opening at the bottom, a 50-50 beam splitter at a 45 degree angle to a bottom section and second and third openings.

9. The laser radar system of claim 1, wherein the first and second detectors convert photon energy to electronic energy with a specified conversion efficiency.

10. The laser radar system of claim 1, wherein the retroflectors comprises three orthogonal planes of reflection having a pyramid type configuration.

11. The laser radar system according to claim 1, wherein the processor means accepts electronic signals from the first and second detectors and converts the signals to analog.

12. The laser radar system of claim 9, wherein the processor means converts analog electronic signals to digital.

13. The laser radar system of claim 1, including a frequency shifter located between the polarizing beam splitter and the internal optics for offset heterodyne properties.

14. The laser radar system of claim 1, wherein the adjustment means of the first, second and third radiation beam expanders include a screw mechanism.
